(19) United States
(12) Patent Application Publication
(10) Pub. No.: US 2026/0261236 A1
(43) Pub. Date: Sep. 3, 2026

(54) SPECTRAL SEPARATION OF LIGHT FOR COLLECTION

(71) Applicant: Microchip Technology Inc., Chandler, AZ (US)

(72) Inventors: Arthur B. Eck, Gilbert, AZ (US); Patrick McFarland, Gilbert, AZ (US); Trent Butcher, Chandler, AZ (US)

(73) Assignee: Microchip Technology Inc., Chandler, AZ (US)

(21) Appl. No.: 19/190,619

(22) Filed: Apr. 26, 2025

Related U.S. Application Data
(60) Provisional application No. 63/764,792, filed on Feb. 28, 2025.

(51) Int. Cl. H02S 40/22; G02B 3/06; G02B 5/04; G02B 19/00

(52) U.S. Cl. CPC H02S 40/22; G02B 19/0009; G02B 19/0042; G02B 3/06; G02B 5/04

(57) ABSTRACT

A method to focus sunlight via a lens onto a prism, disperse sunlight via the prism into different wavelength light rays, capture the dispersed light rays with different photo voltaic cells having different energy bandgaps to convert the light rays to electricity. A system with a lens rod array to focus sunlight, a prism rod array wherein respective prism rods disperse sunlight into different wavelength light ray arrays, different photo voltaic cell arrays wherein respective cells are positioned to capture the different wavelength light ray arrays and have different energy bandgap to convert the different light ray arrays to electricity.

### CROSS-REFERENCE TO RELATED APPLICATIONS

This application claims priority to U.S. Provisional Patent Application No. 63/764,792, filed Feb. 28, 2025, which is hereby incorporated by reference in its entirety as if fully set forth herein.

### TECHNICAL FIELD

The present disclosure relates to solar power generation, in particular, lens and prisms that focus and disperse sunlight into light rays having different wavelengths for conversion to electricity by solar-electricity converters the light rays via photo voltaic semiconductor lattice compound structures that displace photons when subjected to light rays having specific wavelengths.

### BACKGROUND

Solar energy conversion systems provide panel arrays with solar cells that convert solar or radiant energy into electricity. In these systems, all light is primarily collected by similar technology that due to quantum effects this is not ideal for sunlight. Magnifying glasses are used in some cases to reduce demand of photo voltaic (PV) area. This does not improve watts collected per available sunlight. Multilayered semiconductors have been used, often with lens. However, lower layers within the semiconductors tend to be less efficient and the full layer area is typically used for each layer. PV protective glass may have a surface treatment to reduce reflectivity. The common approach is to use one solar cell technology to collect all the light, reducing the amount of sunlight energy that can be converted to electricity.

For a given lattice structure, the valance electron displacement energy is the amount of energy that displaces a valance electron from the valance band to the conduction band. Different lattice structures have different valance electron displacement energy thresholds. Traditional solar panels use silicon. Photon displacement of a valance electron occurs at 1110 nm wavelength. Anything above 1110 nm wavelength is too low a frequency and does not displace a valance electron. Anything below imparts more energy than a threshold so the energy rich electron expels heat into the lattice until all its extra energy is gone. Free electrons are spendthrifts utterly unwilling to share their extra energy with fellow valance electrons to free them. Thus, solar energy conversion systems are inefficient because much of the energy is converted into heat rather than electricity.

There is a need for solar panels with improved photo voltaic solar panel and solar cell efficiency to produce more electricity per solar panel area.

### SUMMARY

According to aspects, there is provided a method comprising: focusing sunlight via a lens onto a prism; dispersing sunlight via the prism into a first range of wavelength light rays and a second range of wavelength light rays; capturing the first range of wavelength light rays with a first photo voltaic cell having a first energy bandgap to convert the first range of wavelength light rays to electricity; and capturing the second range of wavelength light rays with a second photo voltaic cell having a second energy bandgap to convert the second range of wavelength light rays to electricity, wherein the first energy bandgap and the second energy bandgap are different.

Aspects provide a method according to the preceding paragraph, wherein focusing sunlight comprises focusing via a lens rod, and wherein dispersing sunlight comprises dispersing sunlight via a prism rod.

Aspects provide a method according to one of the preceding two paragraphs, comprising: positioning the first photo voltaic cell a first distance from the prism; and positioning the second photo voltaic cell a second distance from the prism, wherein the first distance and the second distance are different.

Aspects provide a method according to one of the preceding three paragraphs, comprising: positioning the first photo voltaic cell at a first angle relative to the prism; and positioning the second photo voltaic cell a second angle relative to the prism, wherein the first angle and the second angle are different.

Aspects provide a method according to one of the preceding four paragraphs, wherein focusing sunlight comprises focusing via an array of lens rods, wherein dispersing sunlight comprises dispersing sunlight via an array of prism rods, wherein capturing the first range of wavelength light rays with a first photo voltaic cell comprises capturing via an array of photo voltaic cells having the first energy bandgap, and wherein capturing the second range of wavelength light rays with a second photo voltaic cell comprises capturing via an array of photo voltaic cells having the second energy bandgap.

Aspects provide a method according to one of the preceding five paragraphs, comprising: distorting sunlight to provide a spatial gap between the first range of wavelength light rays and the second range of wavelength light rays; and positioning the spatial gap between the first photo voltaic cell and the second photo voltaic cell.

Aspects provide a method according to one of the preceding six paragraphs, wherein the first energy bandgap is between 0.20 and 4.10 electron volts, and wherein the second energy bandgap is between 0.20 and 4.10 electron volts.

According to aspects, there is provided a device comprising: a lens to focus sunlight; a prism to receive the focused sunlight and disperse it into a first range of wavelength light rays and a second range of wavelength light rays; a first photo voltaic cell positioned to capture the first range of wavelength light rays and having a first energy bandgap to convert the first range of wavelength light rays to electricity; and a second photo voltaic cell positioned to capture the second range of wavelength light rays and having a second energy bandgap to convert the second range of wavelength light rays to electricity, wherein the first energy bandgap and the second energy bandgap are different.

Aspects provide a device according to the preceding paragraph, wherein the lens comprises a lens rod, and wherein the prism comprises a prism rod.

Aspects provide a device according to one of the preceding two paragraphs, wherein the first photo voltaic cell is positioned a first distance from the prism rod; wherein the second photo voltaic cell is positioned a second distance from the prism rod, wherein the first distance and the second distance are different.

Aspects provide a device according to one of the preceding three paragraphs, wherein the first photo voltaic cell is positioned at a first angle relative to the prism rod; wherein the second photo voltaic cell is positioned at a second angle relative to the prism rod, wherein the first angle and the second angle are different.

Aspects provide a device according to one of the preceding four paragraphs, wherein the lens comprises a lens rod array wherein respective lens rods focus sunlight, wherein the prism comprises a prism rod array wherein respective prism rods disperse sunlight into a first range of wavelength light rays array and a second range of wavelength light rays array, wherein the first photo voltaic cell comprises a first photo voltaic cell array wherein respective first photo voltaic cells are positioned to capture respective light rays of the first range of wavelength light rays array and convert the first range of wavelength light rays array to electricity, and wherein the second photo voltaic cell comprises a second photo voltaic cell array wherein respective second photo voltaic cells are positioned to capture respective light rays of the second range of wavelength light rays array and convert the second range of wavelength light rays array to electricity.

Aspects provide a device according to one of the preceding five paragraphs, wherein the prism is to distort sunlight to provide a spatial gap between the first range of wavelength light rays and the second range of wavelength light rays; and wherein the spatial gap is positioned between the first photo voltaic cell and the second photo voltaic cell.

Aspects provide a device according to one of the preceding six paragraphs, wherein the first energy bandgap is between 0.20 electron volts and 4.10 electron volts, and the second energy bandgap is between 0.20 and 4.10 electron volts.

Aspects provide a device according to one of the preceding seven paragraphs, wherein the first photo voltaic cell comprises silicon energy conversion material, and the second photo voltaic cell comprises an energy conversion material selected from, but not limited to, germanium, gallium arsenic, cadmium tellurium, cadmium zinc tellurium, mercury iodide, gallium phosphide, silicon carbide, gallium nitride, and diamond.

According to aspects, there is provided a system comprising: a lens rod array to focus sunlight; a prism rod array wherein respective prism rods disperse sunlight into a first range of wavelength light ray arrays and a second range of wavelength light rays array; a first photo voltaic cell array wherein respective cells are positioned to capture the first wavelength light ray array and having a first energy bandgap to convert the first wavelength light ray array to electricity; and a second photo voltaic cell array wherein respective cells are positioned to capture the second range of wavelength light rays array and having a second energy bandgap to convert the second range of wavelength light rays array to electricity, wherein the first energy bandgap and the second energy bandgap are different.

Aspects provide a system according to the preceding paragraph, wherein the first photo voltaic cell array is positioned a first distance from the prism rod array; wherein the second photo voltaic cell array is positioned a second distance from the prism rod array, wherein the first distance and the second distance are different, wherein respective cells of the first photo voltaic cell array are positioned at a first angle relative to the prism rod array; wherein respective cells of the second photo voltaic cell array are positioned at a second angle relative to the prism rod array, wherein the first angle and the second angle are different.

Aspects provide a system according to one of the preceding two paragraphs, wherein the first energy bandgap is between 0.20 electron volts and 4.10 electron volts, and the second energy bandgap is between 0.20 and 4.10 electron volts.

Aspects provide a system according to one of the preceding three paragraphs, wherein the first photo voltaic cell array comprises silicon energy conversion material, and the second photo voltaic cell array comprises an energy conversion material selected from, but not limited to, germanium, gallium arsenic, cadmium tellurium, cadmium zinc tellurium, mercury iodide, gallium phosphide, silicon carbide, gallium nitride, and diamond.

### BRIEF DESCRIPTION OF THE DRAWINGS

A more complete understanding of the disclosure and the advantages thereof may be acquired by referring to the following description, taken in conjunction with the accompanying drawings and wherein:

FIG. 1 shows a schematic diagram of sunlight being directed and refracted for collection by wavelength specific solar cells.

FIGS. 2A and 2B show perspective and cross-sectional views, respectively, of a lens rod array, a prism rod array, and a photo voltaic cell array.

FIG. 3 shows a cross-sectional, end view of a prism rod and photo voltaic cells positioned at different distances from the prism rod.

FIG. 4 shows a cross-sectional, end view of a prism rod and photo voltaic cells positioned at different angles relative to the prism rod.

FIG. 5A shows a cross-sectional, end view of a prism rod and photo voltaic cells positioned with spatial gaps relative to adjacent cells.

FIG. 5B shows a cross-sectional, end view of an alternative prism rod and photo voltaic cells positioned with spatial gaps relative to adjacent cells.

FIG. 6 shows a lens rod array, a prism rod array, and a photo voltaic cell array.

FIG. 7 shows a cross-sectional view of a solar-electricity converter.

FIG. 8 shows a solar array.

FIG. 9 shows a flow chart of a method.

The drawings accompanying and forming part of this specification are included to depict certain aspects of the disclosure. The reference number for any illustrated element that appears in multiple different figures has the same meaning across the multiple figures, and the mention or discussion herein of any illustrated element in the context of any particular figure also applies to each other figure, if any, in which that same illustrated element is shown. The features illustrated in the drawings are not necessarily drawn to scale. It may be noted that the features illustrated in the drawings are not necessarily drawn to scale.

### DESCRIPTION

According to aspects, there is provided a solar energy conversion system to refract light and collect energy with the most efficient technology for the particular bandwidth range of the light wavelengths. Light is focused and separated to allow the most efficient semiconductor technology to collect that band of sunlight.

The energy of a photon is related to the frequency of the light it is associated with as determined by E=Pf, where E is energy, P is Planck's constant and f is frequency. Photovoltaic cells are quantum devices that create electron flow by having a proton displace an electron from the valance band to the conduction band. The electron gains enough energy to overcome the bandgap of a given lattice structure. For a given lattice structure, the valance electron displacement energy is different.

Solid State collectors use quantum conversion. Quantum conversion requires a specific energy level to cause event. If insufficient energy is provided by the solar light, the electron will not be displaced from the valence band to the conduction band. If more energy is provided to the electron than that which displaces it from the valence band to the conduction band, the electron will be displaced and the excess energy will be given off as heat.

Given the distribution of energy level of photons at given frequencies, a single semiconductor or solar cell technology can convert photons to electron flow more than 40% of the sunlight energy, other losses lead to real world efficiencies of about 20% typically. By separating or dispersing the light and collecting the various light ray frequencies with various technologies of various bandgap energy levels, estimates show a doubling of energy conversion.

According to aspects, there are provided methods of using lens and prisms to separate light into spectral bands. The lenses and prisms may be made of polycarbonate.

The most efficient photo voltaic PV cells for converting separate light wavelength bands are placed at collection points corresponding to the bands. Photo voltaic cells may comprises an energy conversion material selected from germanium, gallium arsenic, cadmium tellurium, cadmium zinc tellurium, mercury iodide, gallium phosphide, silicon carbide, gallium nitride, and diamond. Photo voltaic cell lattice compound structures may displace electrons at specific wavelengths, as shown in Table 1.

TABLE 1

| | Bandgap (eV) | WaveLength (nm) |
|---|---|---|
| InSb | 0.23 | 5400 |
| Ge | 0.66 | 1880 |
| Si | 1.11 | 1110 |
| GaAs | 1.43 | 870 |
| CdTe | 1.44 | 860 |
| CdZnTe | 1.6 | 776 |
| HgI2 | 2.13 | 583 |
| GaP | 2.26 | 550 |
| SiC | 3.26 | 380 |
| GaN | 3.4 | 365 |
| Diamond | 5.5 | 226 |

In direct sunlight, photo voltaic cells have energy conversion efficiency as shown in Table 2.

TABLE 2

| | |
|---|---|
| Monocrystalline silicon (mono-Si) | 26.1% |
| Polycrystalline silicon (multi-Si) | 23.3% |
| Silicon Heterostructures (HIT) | 27.1% |
| A morphous silicon (a-Si) | 14.0% |
| Monocrystalline gallium arsenide (GaAs) | 29.1% |
| Cadmium telluride (CdTe) | 22.6% |
| Copper indium gallium selenide (CIGS) | 23.6% |
| Dye-sensitised (DSSC) | 13.0% |
| Organic (OSC/OPV) | 19.2% |
| Perovskite (PSC) | 26.1% |

Aspects may provide doubled sunlight energy conversion efficiency and reduced area to collect energy and less semiconductor material to convert energy. This invention may be used to convert sunlight to electricity for energy use. It may be useful for roof top and other locations where space is limited.

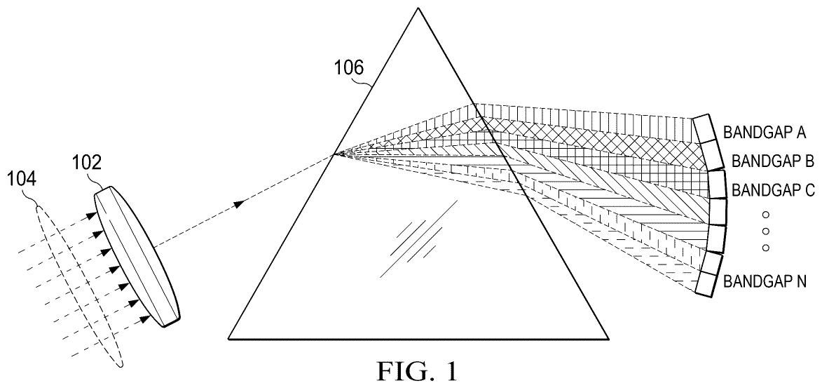

FIG. 1 shows a schematic diagram of sunlight being directed and refracted for collection by wavelength specific solar cells. A lens 102 may focus the sunlight 104 on a prism 106. The prism 106 may refract the sunlight into different wavelength light rays and disperse the light rays on photo voltaic cells 108 positioned to receive the light rays.

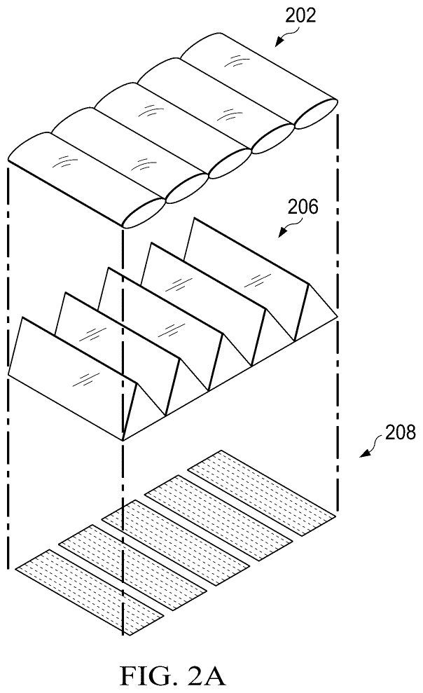

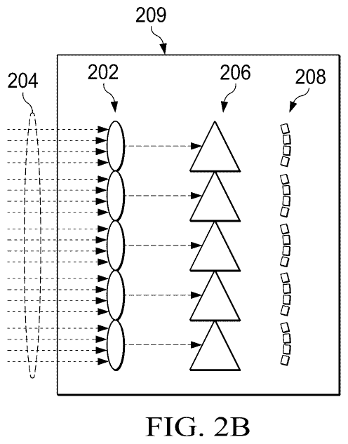

FIGS. 2A and 2B show perspective and cross-sectional views, respectively, of a lens rod array 202, a prism rod array 206, and a photo voltaic cell array 208. As shown in FIG. 2B, sunlight 204 is focused by the lens rod array 202 onto the prism rod array 206. The prism rods refract the sunlight into different wavelength light rays and disperses the light rays on photo voltaic cells positioned to receive the light rays. The arrays may be next to one another side-by-side to make a solar panel 209.

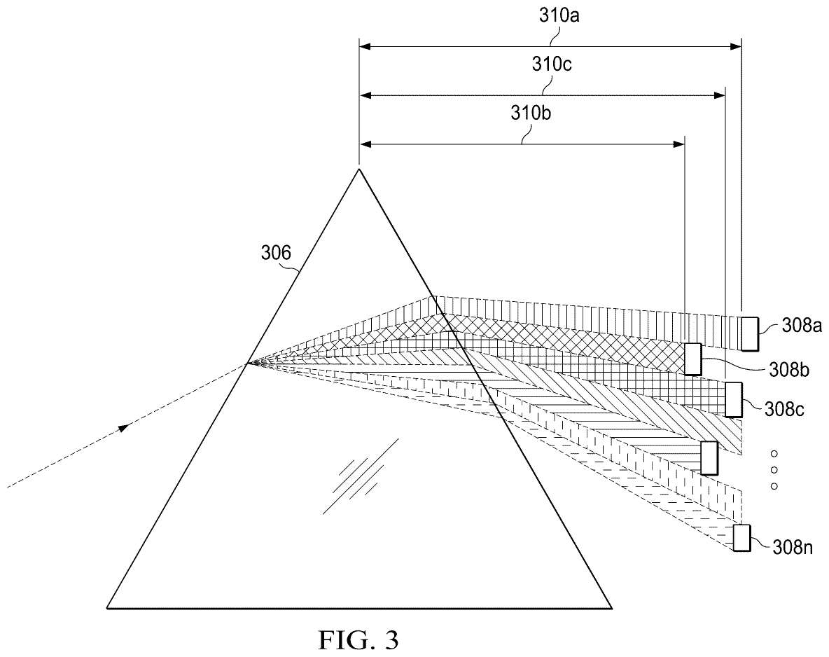

FIG. 3 shows a cross-sectional, end view of a prism rod 306 and photo voltaic cells 308a, 308b, 308c, . . . , 308n. The respective ones of the photo voltaic cells 308 are made of different photo voltaic cell lattice compound structures so as to efficiently convert different ranges of light ray wavelengths into electricity. The photo voltaic cells 308 are positioned at different distances 310a-310c from the prism rod 306 depending on the width of the dispersed light ray passing from the prism rod 306, a bandgap energy level of the photo voltaic cell 308, the intensity of the light ray, or any other factors contributing the efficiency of light-to-electricity conversion. If the photo voltaic cells 308a, 308b, 308c, . . . , 308n are not staggered, the die spacing of different cells may cause losses of focused, dispersed light. Transition loss band may be at end of the bandgap where conversion is less or at sunlight dips.

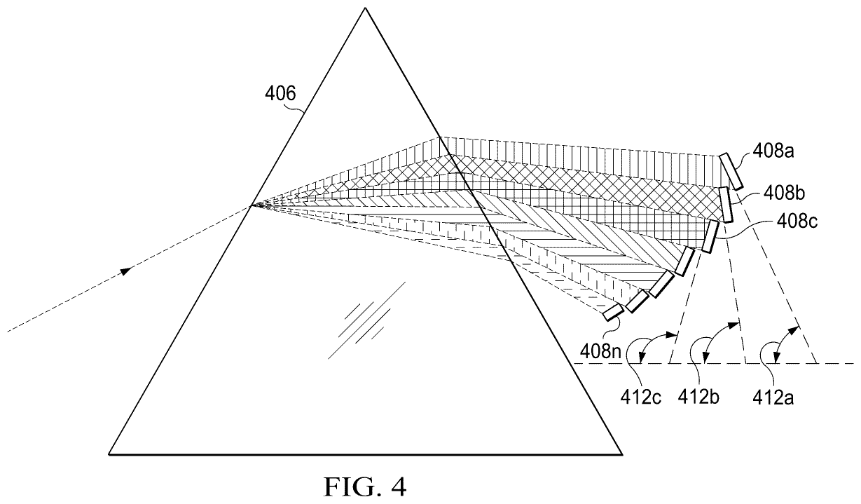

FIG. 4 shows a cross-sectional, end view of a prism rod 406 and photo voltaic cells 408a, 408b, 408c, . . . , 408n. The respective ones of the photo voltaic cells are made of different photo voltaic cell lattice compound structures so as to efficiently convert the different light wavelength light rays into electricity. The photo voltaic cells 408a, 408b, 408c, . . . , 408n are positioned at different angles 412a, 412b, 412c relative to the prism rod 406 depending on the width of the dispersed light ray passing from the prism rod 406, a bandgap energy level of the photo voltaic cell 408, the intensity of the light ray, or any other factors contributing the efficiency of light-to-electricity conversion. Further, the cross-sectional shape of the prism rod 406 may be any shape that efficiently refracts or disperses light. In particular, the cross-sectional shape of the rod may be triangular, or any geometric shape. Surfaces of the prism rod 406 may be multi-faceted to refract, disperse, and focus light.

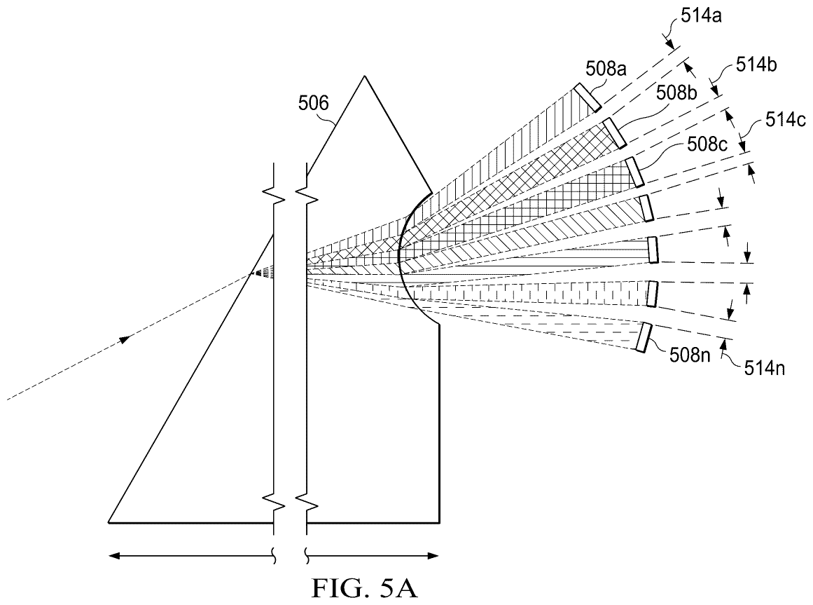

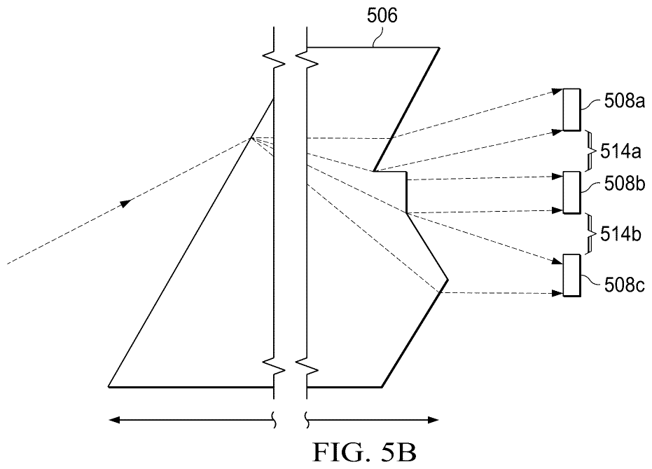

FIG. 5A shows a cross-sectional, end view of a prism rod 506 and photo voltaic cells 508a, 508b, 508c, . . . , 508n. Where there are spatial gaps between the cells, the light may be redirected so that no light falls in the spatial gaps between the cells. By varying the prism surface angle, exiting light may be refracted into bands with spaces between the bands. Exiting light may be focused to land the light rays within a range of light ray wavelengths onto a particular photo voltaic cell. The respective ones of the photo voltaic cells 508 are made of different photo voltaic cell lattice compound structures so as to efficiently convert the different light wavelength light rays into electricity. The photo voltaic cells 508a, 508b, 508c, . . . , 508n are positioned with spatial gaps 514a, 514b, 514c, . . . 514n relative to adjacent cells depending on the width of the dispersed light ray passing from the prism rod 506, a bandgap energy level of the photo voltaic cell 508, the intensity of the light ray, or any other factors contributing the efficiency of light-to-electricity conversion. The prism rod 506 may be wider or elongated to provide more distance between the refractive surfaces to enable redirecting and focusing light to land the light rays within a range of light ray wavelengths onto a particular photo voltaic cell.

FIG. 5B shows a cross-sectional, end view of an alternative prism rod 506 and photo voltaic cells 508a, 508b, 508c. The prism surface angle is varied so that exiting light may be refracted into bands with spatial gaps 514a, 514b between the cells 508a, 508b, 508c. Exiting light may be focused to land the light rays within a range of light ray wavelengths onto a particular photo voltaic cell. The prism rod 506 may be wider or elongated to provide more distance between the refractive surfaces to enable redirecting and focusing light to land the light rays within a range of light ray wavelengths onto a particular photo voltaic cell.

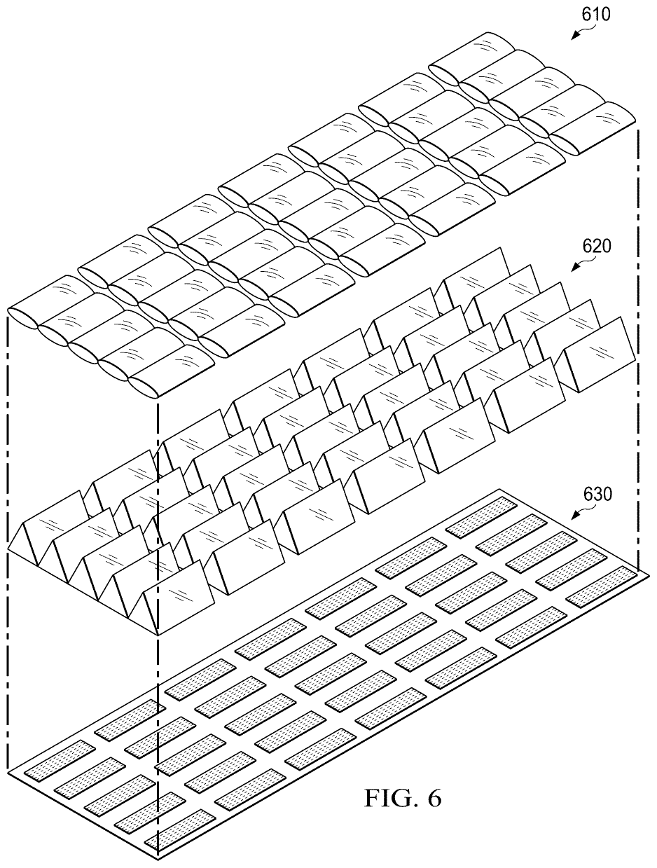

FIG. 6 shows a lens rod array 610, a prism rod array 620, and a photo voltaic cell array 630. The arrays may be stacked vertically on top of one another to make a solar panel, as shown in FIG. 2.

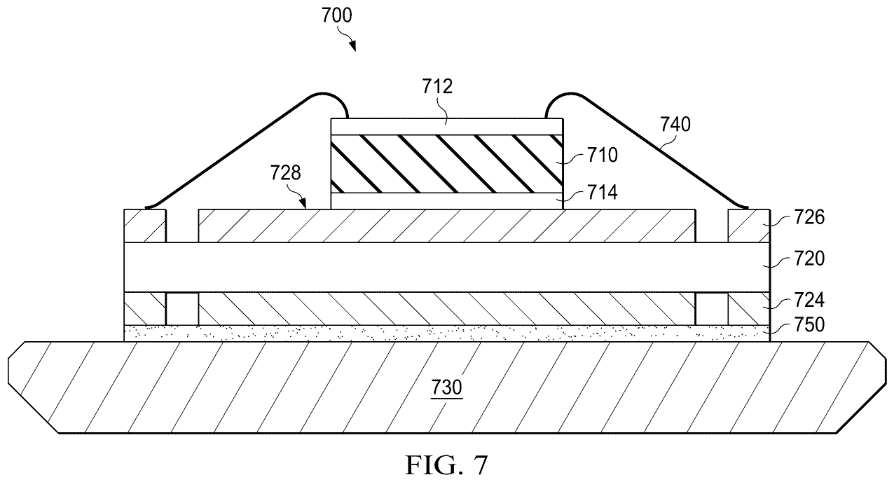

FIG. 7 shows a cross-sectional view of a solar-electricity converter 700. The solar-electricity converter 700 has a photo voltaic cell 710, a substrate 720, and a heat sink 730. The photo voltaic cell 710 has an anode surface 712 and a cathode surface 714. The substrate 720 has a cell-side metalization layer 722 and a sink-side metalization layer 724. The photo voltaic cell 710 is connected to the substrate 720 where the cathode surface 714 is connected to the cell-side metalization layer 722. The cell-side metalization layer 722 has an anode conductive portion 726 and a cathode conductive portion 728. The anode surface 712 of the photo voltaic cell 710 is connected to the anode conductive portion 726 of the substrate 720 via bond wires 740. The cathode surface 714 of the photo voltaic cell 710 is connected to the cathode conductive portion 728 of the substrate 720 via a direct connection, which may be facilitated by an epoxy or other adhesive. The substrate 720 is connected to the heat sink 730, where the sink-side metalization layer 724 is connected to the heat sink 730 via an epoxy adhesive 750, which may comprise a metal-filled epoxy adhesive or solder. Filling an epoxy adhesive such as silicone with metal increases the thermal conductivity of the interface between the substrate 720 and the heat sink 730, further improving the heat transfer characteristics of the solar-electricity converter 700.

The anode conductive portion 726 and a cathode conductive portion 728 are electrically isolated from one another to ensure proper operation of the solar-electricity converter 700. The anode conductive portion 726 and a cathode conductive portion 728 provide terminals (not shown) for electrically connecting the solar-electricity converter 700 to other solar-electricity converters in an array to make a solar panel.

The photo voltaic cell 710 may comprise a photo voltaic cell lattice compound structure that displaces photons when subjected to light rays having a specific wavelength. Thus, different photo voltaic cell 710, having different photo voltaic cell lattice compound structures may be provided to convert solar rays having specific wavelengths into electricity.

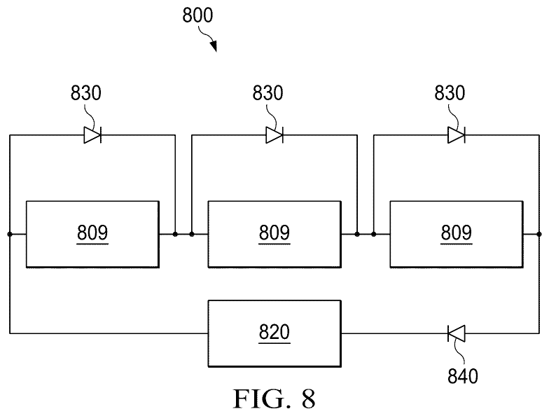

FIG. 8 shows a solar array system 800. The solar power system 800 of FIG. 1 has a plurality of solar panels 809, a plurality of bypass diodes 830, a blocking diode 840 and a converter 820. Solar panels 809 are connected serially, with the positive terminal of the ultimate solar panel 809 connected to the input of converter 820 via blocking diode 840. The return of converter 820 is connected to the return terminal of the first solar panel 809 of the arrangement. Individual solar panels 809 are connected in parallel thereto by a bypass diode 830, arranged to conduct when the return terminal of the solar panel 809 to which it is connected exhibits a positive potential in relation to the positive terminal of that solar panel 809 in accordance with IEC 61215, published by the International Electrotechnical Commission, Geneva, Switzerland, and in particular section 10.18, the entire contents of IEC 61215 is incorporated herein by reference.

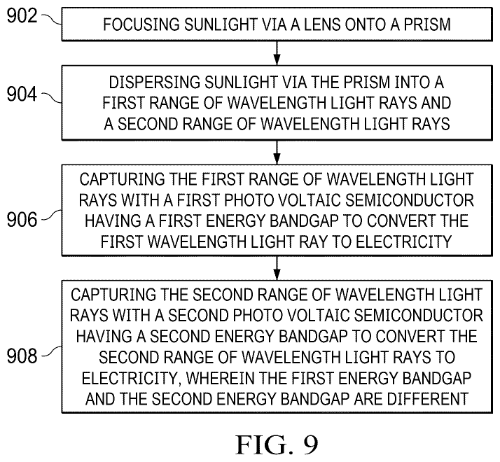

FIG. 9 shows a flow chart of a method. Sunlight is focused 902 via a lens onto a prism. Sunlight is dispersed 904 via the prism into a first wavelength light ray and a second wavelength light ray. The first wavelength light ray is captured 906 with a first photo voltaic cell having a first energy bandgap to convert the first wavelength light ray to electricity. The second wavelength light ray is captured 908 with a second photo voltaic cell having a second energy bandgap to convert the second wavelength light ray to electricity, wherein the first energy bandgap and the second energy bandgap are different.

Although examples have been described above, other variations and examples may be made from this disclosure without departing from the spirit and scope of these disclosed examples.

1. (canceled)

2. (canceled)

3. (canceled)

4. (canceled)

5. (canceled)

6. (canceled)

7. (canceled)

8. A device comprising:
a lens to focus sunlight;
a prism to receive the focused sunlight and disperse it into a first range of wavelength light rays and a second range of wavelength light rays;
a first photo voltaic cell positioned to capture the first range of wavelength light rays and having a first energy bandgap to convert the first wavelength light rays to electricity; and
a second photo voltaic cell positioned to capture the second range of wavelength light rays and having a second energy bandgap to convert the second wavelength light rays to electricity, wherein the first energy bandgap and the second energy bandgap are different.

9. The device as in claim 8, wherein the lens comprises a lens rod, and wherein the prism comprises a prism rod.

10. The device as in claim 8, wherein the first photo voltaic cell is positioned a first distance from the prism rod, and wherein the second photo voltaic cell is positioned a second distance from the prism rod, wherein the first distance and the second distance are different.

11. The device as in claim 8, wherein the first photo voltaic cell is positioned at a first angle relative to the prism rod, and wherein the second photo voltaic cell is positioned at a second angle relative to the prism rod, wherein the first angle and the second angle are different.

12. The device as in claim 8, wherein the lens comprises a lens rod array wherein respective lens rods focus sunlight, wherein the prism comprises a prism rod array wherein respective prism rods disperse sunlight into a first range of wavelength light rays array and a second rage of wavelength light rays array, wherein the first photo voltaic cell comprises a first photo voltaic cell array wherein respective first photo voltaic cells are positioned to capture the first range of wavelength light rays array and convert the first range of wavelength light rays array to electricity, and wherein the second photo voltaic cell comprises a second photo voltaic cell array wherein respective second photo voltaic cells are positioned to capture the second range of wavelength light rays array and convert the second range of wavelength light rays array to electricity.

13. The device as in claim 8,
wherein the prism is to distort sunlight to provide a spatial gap between the first range of wavelength light rays and the second range of wavelength light rays; and
wherein the spatial gap is positioned between the first photo voltaic cell and the second photo voltaic cell.

14. The device as in claim 8, wherein the first energy bandgap is between 0.20 electron volts and 4.10 electron volts, and the second energy bandgap is between 0.20 and 4.10 electron volts.

15. The device as in claim 8, wherein the first photo voltaic cell comprises silicon energy conversion material, and the second photo voltaic cell comprises an energy conversion material selected from germanium, gallium arsenic, cadmium tellurium, cadmium zinc tellurium, mercury iodide, gallium phosphide, silicon carbide, gallium nitride, and diamond.

16. (canceled)

17. (canceled)

18. (canceled)

19. (canceled)

20. (canceled)

21. The device as in claim 8, comprising a solar-electricity converter comprising the first photo voltaic cell or the second photo voltaic cell.

22. The device as in claim 21, wherein the solar-electricity converter comprises a substrate.

23. The device as in claim 21, wherein the solar-electricity converter comprises a heat sink connected to a substrate by an adhesive.

24. The device as in claim 8, comprising:
a first solar panel comprising the lens, the prism, the first photo voltaic cell, and the second photo voltaic cell; and
a second solar panel connected serially with the first solar panel and comprising:
a second lens to focus sunlight;
a second prism to receive the focused sunlight and disperse it into a first range of wavelength light rays and a second range of wavelength light rays;
a third photo voltaic cell positioned to capture the first range of wavelength light rays and having a first energy bandgap to convert the first wavelength light rays to electricity; and
a fourth photo voltaic cell positioned to capture the second range of wavelength light rays and having a second energy bandgap to convert the second wavelength light rays to electricity.

25. The device as in claim 24, wherein the first solar panel has a first positive terminal and a first return terminal, wherein the second solar panel has a second positive terminal and a second return terminal, and the device comprising:
a first bypass diode connected to the first positive terminal and the first return terminal and a second bypass diode connected to the second positive terminal and the second return terminal;
a blocking diode connected to the second positive terminal; and
a converter connected to the first return terminal and the blocking diode.

26. The device as in claim 8, wherein the first and second photo voltaic cells are positioned so that no light falls in a spatial gap between the first and second photo voltaic cells.

27. The device as in claim 8, wherein a prism surface angle is varied so that light exiting the prism is to be refracted into bands by a spatial gap between the first and second photo voltaic cells.
